(19) United States
(12) Patent Application Publication
(10) Pub. No.: US 2026/0239466 A1
(43) Pub. Date: Aug. 13, 2026

(54) SEPARATING END-TO-END TRUST DOMAINS WITH CELLULAR TECHNOLOGY

(71) Applicant: Telefonaktiebolaget LM Ericsson (publ), Stockholm (SE)

(72) Inventor: Friedhelm RAMME, Jülich (DE)

(73) Assignee: Telefonaktiebolaget LM Ericsson (publ), Stockholm (SE)

(21) Appl. No.: 19/153,979

(22) PCT Filed: Feb. 6, 2024
(86) PCT No.: PCT/EP2024/052889

§ 371 Date: Aug. 6, 2025

Related U.S. Application Data
(60) Provisional application No. 63/443,679, filed on Feb. 6, 2023.

(51) Int. Cl. H04W 76/15

(52) U.S. Cl. CPC H04W 76/15

(57) ABSTRACT

A communication device can receive information from a first external application server via a first network slice of a communications network. The communication device can further communicate with a second external application server via a second network slice of the communications network based on the information.

### TECHNICAL FIELD

The present disclosure is related to wireless communication systems and more particularly to separating end-to-end trust domains with cellular technology.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

When it comes to Connected Vehicle (“CV”) operation and wireless communication, it can be important to use wireless communication for Vehicle-to-Vehicle (“V2V”) and Vehicle-to-Infrastructure (“V2I”) communication in order to save lives, avoid injuries, and safeguard efficient and environment friendly road traffic operation. To achieve these goals, a wireless communication channel between a responsible local authority (e.g., a Road Traffic Authority (“RTA”); Road Operator (“RO”); or Infrastructure Owner Operator (“IOO”)) and CVs (driving in the geographical area for which the local authority is responsible) may be required. In the illustrated examples, this communication channel includes a Traffic Management Center (“TMC”), or a plurality of TMCs, associated with the local authority. These communication channels can allow information to be communicated between local authorities (e.g., traffic authorities or ROs (and their TMCs)) and CVs that drive within the geographic area of the TMC's operation responsibility and to receive information from such CVs for further processing at the local authorities' TMCs. The area of responsibility is most often defined by a geographic area and/or defined via road categories at a geographic area.

In some examples, the information being communicated can relate to the higher goal of saving lives, avoiding injuries, and facilitating an efficient and environmentally friendly road traffic operation. The information can support multi-modal passenger travel and/or support a system for providing trucking parking capacity. The information can include Safety Related Traffic Information (“SRTI”) and (real-time) road traffic and road status information (“RTTI”); all kinds of warning messages or information messages such as congestion, charging area or pollution sensitive area ahead, or traffic light status information (e.g., Signal Phase and Timing (“SPAT”) data). The information can include electronic traffic sign information for vehicles nearby (e.g., in-vehicle signage).

### SUMMARY

According to some embodiments, a method of operating a communication device is provided. The method includes receiving information from a first external application server via a first network slice of a communications network. The method further includes communicating with a second external application server via a second network slice based on the information.

According to other embodiments, a method of operating a node is provided. The method includes communicating information with a local authority associated with a geographical location of a communication device. The method further includes communicating the information with the communication device via a second network slice. The second network slice is separate from a first network slice that is associated with a remote entity associated with the communication device.

According to other embodiments, a method of operating a node configured to provide a first external application server is provided. The method includes, transmitting an indication of a certificate to a communication device via a first network slice. The method further includes transmitting a first message to a second external application server, the first message requesting that the certificate be added to messages transmitted by the second external application server to the communication device via a second network slice that is separate from the first network slice.

According to other embodiments, a communication device (e.g., part of a manned vehicle, unmanned vehicle, or drone), a node (e.g., a network node, a node configured to provide an external application server, or a gateway), a system, a host, a computer program, a computer program product, or a non-transitory computer readable medium is provided to perform one of the above methods.

Certain embodiments may provide one or more of the following technical advantages. In order to implement the outlined feasibility assumptions, the following tasks demand a solution and a system composition that establishes the goal of operating two fully separated trust domains, to/from a given vehicle, by sharing the same wireless cellular wide-range communication channel, determined and contracted by the vehicle manufacturer for global (cross-country) CV service operation.

In some embodiments, the proposed system includes full isolation of the in-vehicle software services and their execution, within a given CV.

In additional or alternative embodiments, the proposed system includes establishment of two (or more) independent wireless wide-range connections to/from a CV via a 3GPP cellular network that supports network slicing.

In additional or alternative embodiments, the proposed system allows two (or more) network slices, sharing the same modem and SIM at a CV, to have two different termination points at two different trust domains, without sharing a common point of control outside of a given CV. In some examples, it may be required to route via a central OEM IT backend.

In additional or alternative embodiments, the proposed system allows the OEM in question to maintain control over the utilization of the second (C-ITD data) channel (into a second (RO) trust domain) that is not routed via the OEM IT backend.

In additional or alternative embodiments, the proposed system allows a 3rd party (e.g., a contracted auditing party such as PricewaterhouseCoopers (“PWC”) acting on behalf of a RO or government) to audit, at any point in time, its own (C-ITS) RO trust channel, including the channel end points, to assure that no data from a trust domain other than its own (C-ITS) RO trust channel, got transported in or via its own (C-ITS) RO trust channel and its own trust domain.

The above embodiments can form the foundation of a multi-party end-to-end business architecture, including cost coverage and operations responsibilities, and liability aspects, which solve the still open eco-system conflict between commercial CV service operation and society-geared C-ITS safety and road traffic efficiency services for the greater good, utilizing a shared cellular network communication infrastructure.

In some examples, the proposed system ensures that the potentially sensitive C-ITS data does not need to leave the country at which the CVs in question are driving. Irrespectively of the host country to which the corresponding commercial OEM CV services connect.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a schematic diagram illustrating an example of separated V2X communication channels;

FIG. 3 is a schematic diagram illustrating an example of the separated V2X communication channels of FIG. 2 enhanced by a C-ITS data exchange system or data exchange network of system nodes;

FIG. 4 is a schematic diagram illustrating an example of cellular wide-range end-to-end C-ITS trust domain separation in accordance with some embodiments;

FIG. 5 is a flow chart illustrating an example of operations performed by a communication device in accordance with some embodiments;

FIGS. 6-7 are flow charts illustrating examples of operations performed by a node in accordance with some embodiments;

FIG. 8 is a block diagram of a communication system in accordance with some embodiments;

FIG. 9 is a block diagram of a user equipment in accordance with some embodiments;

FIG. 10 is a block diagram of a network node in accordance with some embodiments;

FIG. 11 is a block diagram of a host computer communicating with a user equipment in accordance with some embodiments;

FIG. 12 is a block diagram of a virtualization environment in accordance with some embodiments; and

FIG. 13 is a block diagram of a host computer communicating via a base station with a user equipment over a partially wireless connection in accordance with some embodiments.

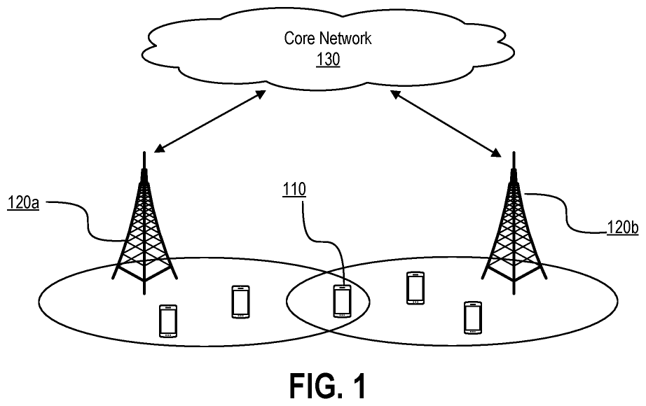

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

A communication channel between a responsible local authority (e.g., a Road Traffic Authority (“RTA”); Road Operator (“RO”); or Infrastructure Owner Operator (“IOO”)) and connected vehicles (“CVs”) (driving in the geographical area for which the local authority is responsible) can use vehicles, at a certain geographic area, as “data sensors” and as “data destinations”. The data to be communicated can be very sensitive, can be time critical, and can be associated with time-to-live key performance indicators (“KPIs”). Legislation in some countries and/or global regions may require that corresponding data not leave the country/regional borders. This implies that the CV data channel between the CV and the local authority for such data needs to terminate at the originating country. The process required for the data exchange needs a safeguard such that only authentic information is being exchanged via that channel, with senders and receivers being identifiable or at least authorized for sending such information. Consequently, this data exchange channel between a given CV and the corresponding TMC/RO/RTA may need to be part of a well-protected and well-governed trust domain.

This trust domain between a given CV and a government-entitled road traffic management authority, is by nature different to the trust domain between a CV and the IT backend system of its vehicle manufacturer (“OEM”). The latter, for example, provides digital services (e.g., OEM telematic services) and vehicle maintenance services (such as over-the-air (“OTA”)/firmware-over-the-air (“FOTA”) update services). Both groups of services may share the same cellular wide-range communication technology underneath.

OEM CV services, however, are most often operated from centralized cross-country OEM IT backend systems. To maximize (de-facto) the cellular network connectivity of any given CV, OEMs sign global cellular connectivity contracts with leading Communication Service Providers (“CSPs”) and in many cases equip their CVs with a permanent roaming subscription (under OEM contract control). In this way, national roaming limitations, common for consumer subscriptions, can be circumvented and the probability that a cellular connection enabled CV connects can be maximized.

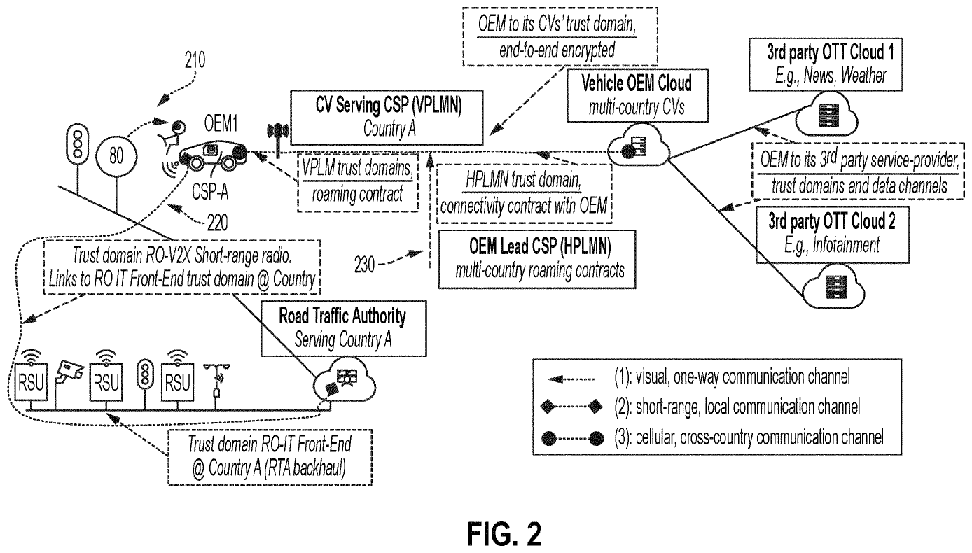

FIG. 2 illustrates an example of a traditional deployment situation with three overarching means for communication between a CV (and/or its driver) and a RO. The first means for communication between the CV and the RO is a traditional one-way human centric visual communication channel 210 via traditional road traffic signs (e.g., a driver of the CV being able to receive information from a RO by viewing a traffic sign, including traffic signs that are flexible and can be adapted by the RO to the circumstances, e.g. variable speed limits, warnings etc .. Accordingly, the visual communication channel 210 can constitute a TMC-to-CV communication channel.

The second means for communication between the CV and the RO is a short-range communication channel 220. A Vehicle-to-Infrastructure (“V2I”) variant of this short-range channel terminates a road-side unit (“RSU”) under trust and operation supervision of a RO/RTA/IOO. The RSU can be integrated with an electric traffic sign with a traffic light controller or a TMC IT system. Accordingly, the short-range communication channel 220 can constitute a dedicated trust domain to the regional RO/RTA/IOO.

In some examples, this domain covers traffic signs with some kind of (fixed or wireless) connection to the Road Operator's TMCs, and can include Road-Side-Units (“RSUs”), which can provide short-range wireless connections between the RO's IT systems and CVs in the area of the RO's responsibility.

The third means for communication between the CV and the RO includes a cellular wide-range communication channel 230, which can constitute a (global) OEMs' trust domains for delivering non-OEM services and (global) OEMs' trust domains that connects the OEMs' centralized and potentially cross-country CV service delivery backend system with the OEM's CVs, in each country or region. Example services of this category include road weather services, news, or media streaming services. The contract and business relations in these 3^{rd} party services domains are governed by each OEM according to its business rational.

Due to the OEM's priority to have its CVs connect via cellular wide-range networks, wherever cellular coverage is provided, CVs can be operated in permanent home roaming constellations, with corresponding roaming subscriber identity modules (“SIMs”) deployed. The end-to-end communication channel between the OEM IT backend and its CVs is end-to-end encrypted and can form an overarching trust domain.

The trust domain provided by the short-range wireless communication channel 220 can be under full RO control. The same trust domain may carry an RSU short-range communication infrastructure, connecting on its one end the RO's IT systems and on its other end to CVs with corresponding 5,9 GHz short-range C-ITS wireless communication technology integrated and active. Thereby this trust domain can also implement a digital two-way communication channel to CVs driving at the RO's area of responsibility, subject to global harmonization of the short-range technology and services, and subject to mass-volume deployments of CVs with such technology and services. Despite more than twenty years of efforts, the latter remains an open issue.

The trust domain provided by the cellular wide-range communication channel 230 can be under full OEM control. It implements a cellular wide-range communication channel between the centralized (cross-country) OEM's IT backend system and the OEM's CVs, driving at the various countries. This OEM CV communication channel is de-facto not accessible by any of the many national, regional, or sub-regional ROs and via their TMCs. Even if it was accessible, a global and scalable deployment and operation solution, that also addresses the cost and business responsibility aspects, is not available.

Next to the difference in trust relations between a TMC/RO/RTA communication channel (to/from a CV) and other kinds of communication channels (to/from the same CV), is the difference in business interest and the KPIs that cater for the channel operation cost and the underlying business interest.

ROs and RTAs are the executing body of national transport ministries. TMCs are the operation entities of the respective road operator. Jointly they represent the society interest in operating and maintaining a safe and efficient road transportation infrastructure. Their operation and infrastructure cost can be funded via public taxes. In some examples, their cost is covered via road usage tolls and thereby via an indirect taxation. Their KPIs are for example: Number of accidents or lengths of traffic jams or utilization of their road traffic networks. ROs provide society services for the greater good. Their prime KPIs are non-monetary. Cost and cost coverage is associated with the road infrastructure build, with its maintenance, and with the road traffic operation and operation of related systems (e.g., TMCs).

The US Government Accountability Office (“GAO”), an internal government control office that examines the use of public funds, estimates that the US benefits of deploying CV safety services are likely to reach over $800 billion with the reduction of costs associated with public safety and first responder response to crashes as well as insurance and medical costs associated with fatalities, severe injuries, and property damage.

The other groups of CV services are primarily driven by business interest of a given OEM or vehicle service provider. The corresponding business rational may be justified by monetary KPIs.

This can embed a natural eco-system conflict on the cost coverage for a given service operation and a misalignment in the nature of the underlying service KPIs. Enforced regulations (e.g., as part of a vehicle type approval procedure) aim to mitigate this conflict between business interest and society interest.

A further conflict mitigation process is the complete split of the required digital service operation infrastructure. By nature, a fully separated communication channel infrastructure inherits the full separation of trust domains, of operation and maintenance cost, and responsibilities. Examples in road traffic management for such a full separation of communication infrastructure are the Terrestrial Trunked Radio (“TETRA”) communication network for road safety reports and for acting RO personal; or the deployment of traffic-signs for human drivers and for camera-equipped vehicles that utilize such a visual communication channel. FIG. 2 illustrates an example of three independent communication channels to road vehicles (and/or their drivers), each utilizing its own infrastructure.

This state-of-the-art infrastructure separation is a most costly and resource consuming implementation of a “communication channel deployment and operation”. And thereby a most costly and resource consuming solution to the goal of “separating trust domains, operation cost and responsibilities.”

One other such separation of communication channels (and trust domains), via a dedicated communication infrastructure, is the concept of deploying RSUs and using Dedicated Short-Range Communication (“DSRC”) or a similar short-range communication technology (e.g., ITS-G5, or LTE-V2X sidelink, or 5G-V2X sidelink) with a dedicated and global harmonized spectrum at 5.9 GHz and globally standardized communication protocols and vehicle safety services. Regulatory enforcements could mandate OEMs to equip new vehicles with one of these dedicated communication technologies. However, this is also a very costly solution that has not gained much deployment traction, despite more than two decades of heavy investments and pilot test deployments around the world.

The US Federal Department of Transportation (“D.O. T”) estimates that their nation's investments into CV (e.g., DSRC short-range) related collective efforts totaled more than $2.7 billion, which included direct federal investments of about $804 million into research and testing of CV systems. There currently exist certain challenges. Several counties have defined a “vision zero” for road fatalities. Their governments have set big funds aside to achieve this vision. Local authorities (e.g., ROs and RTAs) can be part of the executive bodies of the governments. For example, the local authorities can be under the national Ministries for Transportation (in Europe) or State D.O.T.(s) in the US.

In some examples, ROs would like to reach out to CVs with important road safety information and warn drivers (in time) about potential hazards, traffic jams, and other such information. The information can include road status information from electronic message signs and from connected road traffic lights. This can refer to the infrastructure (“I”) in vehicle-to-infrastructure (“V2I”). In some examples, the ROs (and governments) represent the society interest in this “vison zero” ambition. Their operation is financed via national tax income.

Building road infrastructure, maintaining the infrastructure, and operating the road traffic flow controls is part of their duties.

Corresponding information is processed and available at the regional TMCs. The information is relevant for CVs driving at the road network under the RO's TMC responsibility. A RO or RTA has typically dozens of TMCs in its operations area. There can be several ROs/RTAs per country. Connected vehicle services of a given remote entity (e.g., an OEM), on the other hand, are typically operated from a central cross-country OEM IT Backend system.

The cellular network connection between a CV and its OEM IT backend system is end-to-end encrypted. Data traveling via this encrypted channel is under full control of, and with exclusive access and visibility by, the corresponding OEM.

This leaves national ROs/RTAs de-facto with the lack of a digital communication channel to/from the connected vehicles in their operations area. Despite big efforts they failed getting access to CV data via the OEMs. In order to get a communication channel for such purposes, the idea of using a dedicated short-range wireless communication technology, with corresponding protocol stacks and security structures standardized and with its implementation enforced via legislative and regulatory measures, has been attempted.

To facilitate the implementation of the short-range communication concept, dedicated C-ITS spectrum at 5.9 GHz has been set aside. Mandates to OEMs to deploy such short-range communication technologies have been discussed. The idea to deploy a dedicated communication infrastructure, based on short-range RSUs, has been developed in streams of research and pilot deployment projects (including e.g., US V2X deployment acceleration efforts). The technology foundation (in Europe today) is ETSI ITS G5 (alias 802.11p alias pWLAN) and DSRC (in other parts of the works). Billions of EURs have been spent in RO or government led test and trial projects and research studies, without much success from a commercial/public operations perspective. The European Commission continues to drive such ambitions.

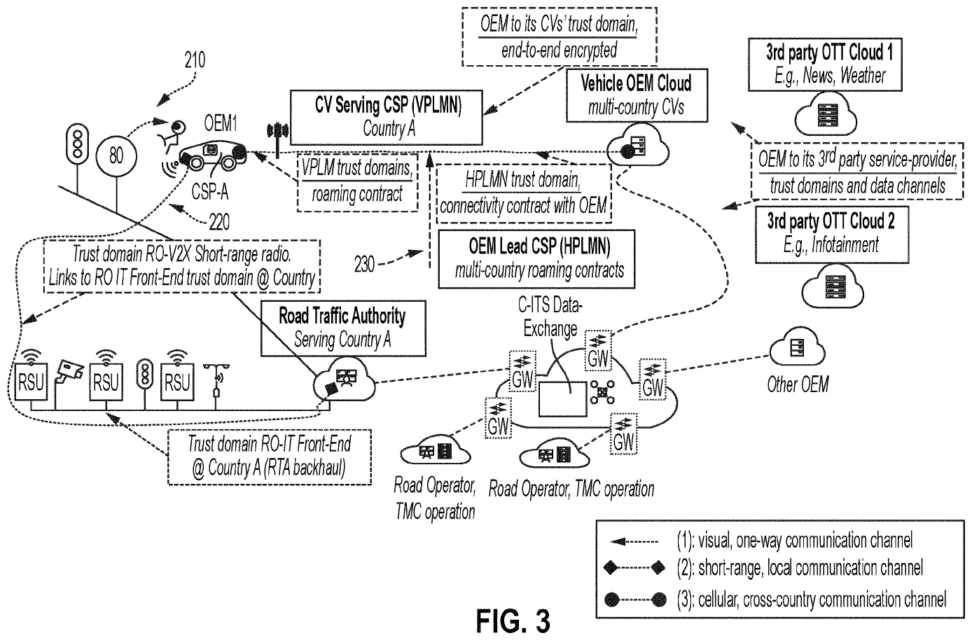

With the emergence of capable cellular networks, starting with 4G, with the steadily improving cellular wide-range coverage, and with more and more CVs deployed with factory fitted cellular communication, governments and the European Commission considered mandates (Delegated Acts) as a means to force OEMs to make SRTI information available (in anonymized forms) from their connected vehicle fleets, free of charge for end-users. In a similar way public transportation providers and ROs are requested to make their SRTI and Transport mobility information available. The idea is that these parties interchange such data via their backends and corresponding (cloud) integration points, illustrated by the “C-ITS Data-Exchange” in FIG. 3. The OEMs are assumed to use their (paid) cellular communication channel to their CVs to retrieve and provide SRTI information. A recent European data-sharing effort along this concept is the Data for Road Safety Initiative (“DRSI”).

DRSI was considered as a tool to help the European target to reduce the number of fatal road crashes, victims, and serious injuries, by half by 2030. In order to achieve the set targets for road safety, the European Commission Road Safety Policy Framework 2021-2030 outlines possible next steps and approaches, including safe systems and new technological advances as well as opportunities of connectivity and automation. Another concept pushed by the European Commission to facilitate the SRTI data exchange is to establish National-Access-Points (“NAPs”) and to have a central European Access-Point, that refers to the National Access-Points, to retrieve and deliver national SRTI and RTTI information.

These data exchange concepts remain very much aspirational, despite the political pressure, regulatory forces and despite substantial tax money that is being provided in Europe and the US. This can leave national governments (and the global society, dealing with vehicles safety services and road traffic efficiency improvements via CVs) with no deployed large-scale solution to provide safer and more efficient road traffic operation.

Road Traffic Operators, who are financed via tax money by their local/national jurisdictions, could carry the cost and responsibility of deploying a dedicated short-range wireless communication infrastructure, based on RSUs. They could connect their digital road traffic signs and traffic light controllers via RSUs to their TMCs. Information sharing to/from CV would happen via short-range wireless communication systems, connected to the RO's TMCs' IT backends (see e.g., short-range wireless communications channel 220, which is within the RO trust domain).

The deployment of corresponding short-range wireless communication modules, and of the standardized C-ITS services by OEMs in their new CVs could be voluntary or become enforced via national/regional regulations and/or via vehicle type approval regulations.

That way a dedicated digital C-ITS communication channel with a fully separated trust domain (compared to commercial CV telematics or infotainment services) could be established.

An alternative option can work via the OEMs' CV cellular wide-range connectivity. The end-to-end encryption of said channel would imply that all C-V2X relevant data exchange travels via the centralized cross-country OEM IT Backends, back to the national/reginal road operator and to the TMC in the country's geographic area where a given vehicle is driving (see e.g., the “C-ITS Data-Exchange” concept extension in FIG. 3.) Such a delivery path would imply that OEMs are willing to share C-ITS relevant safety and/or traffic efficiency relevant data to/from their central IT backend systems and shoulder the related cost.

Considering the many OEMs (and respectively the many OEM IT backend systems)—put in a gateway role and function for this concept to work—and the many TMCs in the various countries—this concept would further-on require a multi backend-to-backend (or multi cloud-to-cloud) cross-country and cross-authority C-ITS data sharing system infrastructure.

OEMs' could be requested (or required) to share safety related data, in an anonymized way, free of charge for end-users. The European ITS Directives are already providing the corresponding foundations. Several OEMs have agreed to sharing such data.

The C-ITS data exchange could be arranged in a centralized way, e.g. via special service providers, or as part of an HD map service with real-time information enhancements, or in a more distributed manner (similar to a distributed cross-country IP-based internet router structure). The European Commission is promoting the concept of (central) “National Access-Points (NAPs)” as a country specific data exchange, with a dedicated European Access-Point as global root.

An example of a C-ITS data sharing platform, with a more distributed deployment option, is the NordicWay concept of federated Inter-Change Nodes. This already tested concept provides a feasibility reference case for such a distributed operation structure. Yet it does not address the remaining conflict in the business architecture. Meaning, the cost coverage for the C-ITS data handling along its end-to-end transportation path via the C-ITS Data-Exchange to all the CVs in the respective countries.

This means that a data sharing solution concepts for SRTI-like data sharing between the parties' backend systems can be made available. It also means that OEMs would, in principle, be willing to share related information under the condition that they can receive corresponding quality data from other OEMs and from the various national ROs.

What remains open are the operations responsibilities (and attached liabilities) and the incurred cost coverage.

By just using the OEM-contracted cellular wide-range communication channel to the OEMs' CVs, a separation of trust domains between the OEM controlled commercial CV services and the society related C-ITS services is not possible. Given that every OEM is carrying the data communication cost and operations responsibility for their national or cross-country cellular wide-range communication to/from their CVs, also the cost inherited by the C-ITS society services would go with the OEM's account.

This cost compensation issue, together with potential liability aspects, constitutes a major market deployment hinderer for this concept (compared to a dedicated short-range communication channel and its communication infrastructure).

The global deployment of the first option described above is hampered by two competing wireless short-range technologies and camps. Namely: DSRC and ITS-G5 vs. C-V2X direct (or LTE-V2X direct or 5G-V2X direct, or sidelink). In some countries this is hindered by national 5.9 GHz spectrum regulations that permit one or the other of these short-range technologies. And it is hindered by the very long time it takes until a high penetration of C-V2X short-range equipped vehicles will be deployed by all OEMs at all the OEM's target markets.

The global deployment of second option described above is hindered by OEMs resistance to carry the communication cost of non-billable C-ITS safety services that travel via the OEM paid cellular wide-range connections. And by security and trust concerns when allowing the many national/regional road operators to gain access to the OEM's CVs via the OEM central CV service backend(s).

This implies that the first option has the theoretical potential to deliver a dedicated (short-range) CV communication channel with a full separation of the trust domains, but has been unable to be successfully implemented. The second option could promise a much faster market penetration, but is stuck in a mixture of cost coverage and from merging conflicting trust domains, responsibilities, and liability questions.

Certain aspects of the disclosure and their embodiments may provide solutions to these or other challenges. In some embodiments, a system and/or process is described that allows the full end-to-end separation of trust domains and separation of the associated wireless cellular wide-range communication channels. It thereby embeds a procedure that clarifies operation responsibilities between the two service groups (commercial OEM services and society-geared C-ITS services), and their inherited KPIs (e.g., monetary business interest vs. society interest). It paves the way forward to resolve the still pending cost coverage issue when cellular wide-range communication, under a given OEM contract, with its deployment setting and control, shall be re-used. In some examples, these innovations build on to the second option described above to make it deployable from a business operation perspective.

In additional or alternative embodiments, the proposed process allows 3rd party audits to re-assure a public (national) entity that the communication system configuration, potentially financed by a public entity, is not mis-used to subsidize commercial OEM CV service operation.

In some examples, the implementation operates on the following two assumptions. First, the commercial OEM service execution, at a given CV, can be fully separated from RO (society C-ITS) service execution at the in-vehicle on-board platform(s). This separation can be done in a way that a 3rd party auditor, at any point in time, can inspect any involved CV to check that only pre-certified C-ITS RO services, at that vehicle, connect to the RO trust domain and to its related cellular CV communication channel(s). Second, the CV in question connects to its respective OEM IT backend and simultaneously to a “national RO data endpoint (or RO IT backend or C-ITS data exchange system)”, without passing the OEM IT backend. The CV in question is using a single 3GPP compliant cellular network modem instance with one modem SIM. The SIM and the SIM profile is determined by the OEM's global connectivity contract (sometimes referred to as a visited public land mobile network (“VPLMN”)).

A “national RO data endpoint” can be represented by a Gateway (“GW”) instance at an independent C-ITS trust domain, an Application Server at a RO IT backend, or a national access point (“NAP”) for the cross-OEM, cross-RO, cross-SP and/or cross-CSP exchange of C-ITS data. The CV communication channel to such a “national RO data endpoint” is via a cellular 3GPP wide-range network (Uu interface) at the cellular network that provides the radio access service to the CV via the OEM's global connectivity contract relation.

The cellular network in question, providing the wireless wide-range connectivity to a CV in question, can support 3GPP network slicing. Network Slicing, in this context, can require at least an LTE vEPC as core network capability. The concept naturally evolves to Network Slicing in a 5G (or subsequent generations) SA, including radio network partitioning capabilities.

Although this second (C-ITS) wireless communication channel may not pass via the central OEM IT backend system, the structural solution permits the OEM in question to maintain control over the utilization of this second communication channel. The structure suggested allows the OEM in question to block the C-ITS data channel at any point in time, if the OEM deems needed.

Various embodiments herein describe separating end-to-end trust domains with cellular technology. In some embodiments, a communication device is able to communicate with two different entities via the separate end-to-end trust domains.

In some examples, the communication device is (or is part of) a connected vehicle (“CV”). In additional or alternative examples, the communication device is a manned (e.g., human-operated) vehicle or an unmanned vehicle (e.g., an autonomous or remote controlled vehicle). In additional or alternative examples, the vehicle includes at least one of a road vehicle (e.g., a car, truck, or bus), a rail vehicle (e.g., a train), a water vehicle (e.g., a ship), or an air vehicle (e.g., a plane or helicopter). In additional or alternative examples, one entity is a remote entity (e.g., an Original Equipment Manufacturer (“OEM”) associated with the vehicle) and the other entity is a local authority (e.g., a Road Operator (“RO”) associated with roads near the vehicle).

In additional or alternative examples, the communication device is a robot or drone. In additional or alternative examples, one entity is a remote entity (e.g., an Original Equipment Manufacturer (“OEM”) associated with a drone or an operator of a drone) and the other entity is a local authority (e.g., an air space controller associated with airspace near the drone).

In some embodiments, full separation of end-to-end C-ITS services, data-flows, and all related system operations, including all user-plane system nodes-from commercial CV services and service delivering system nodes-is achieved. In some examples, the RO trust domain is extended via a national or cross-country “C-ITS Data-Exchange” to a connected OEM vehicle, driving at the area of responsibility of a given RO.

The “C-ITS Data-Exchange” (depictured in FIG. 3) is considered to become an extension of the RO trust domain via its connection to the various ROs' IT backends.

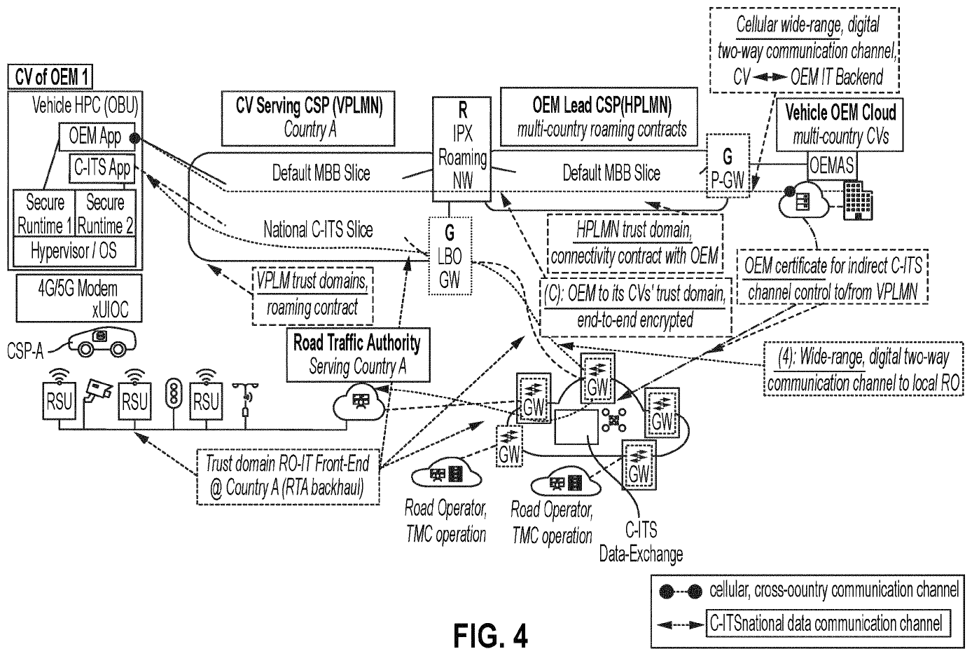

In some embodiments, cellular wide-range connected vehicles and the global connectivity contract structure (and CV SIM profile) are used as determined by the (global) CV OEM. However, the C-ITS data is able to be communicated to the CV without passing through the cross-country OEM IT Backend (as illustrated in FIG. 4).

This separation of data flows and user-plane system nodes can be achieved via 3GPP core network slicing, starting with 4G and vEPC deployments, at the VPLMN (FIG. 2, FIG. 3) and by utilizing a Local Breakout Gateway (“LBO”) at the VPLMN network that in fact serves the CV in question (see FIG. 4). Instead of having the OEM IT Backend connected to the “C-ITS Data-Exchange” (suggested by FIG. 3) now the LBO of the VPLMN, at the given country in which the CV is driving, connects to the “C-ITS Data-Exchange” (see FIG. 4).

The full separation of C-ITS service execution, at the in-vehicle system, while sharing a common modem, a single SIM and antenna system, can be achieved by deploying C-ITS services and commercial OEM services at different physical execution-units within the vehicle (as a network behind a cellular UE structure). Or via deployments in so called “Virtual Machines”, utilizing the software execution separation provided by a hypervisor function of the upcoming centralized high-performance compute-units of latest in-vehicle software architectures. This now further extends the RO trust domain from FIG. 2 via the “C-ITS Data-Exchange” (FIG. 3) via a LBO gateway, a dedicated C-ITS network slice at a national VPLMN network, to a corresponding C-ITS service execution environment at the in-vehicle system architecture (FIG. 4).

In some embodiments, at any point in time, a 3^{rd} party auditor can inspect a given CV and the end-to-end data flow operation at an involved VPLMN, that only C-ITS services and data flows are executed by and within this extended RO trust domain. In case the corresponding operation would be financed by public funds this auditing procedure could verify that no tax money is subsidizing commercial CV services via a shared cellular network usage at the VPLMN or at the CV in question.

Although all C-ITS data flows bypasses the central OEM IT Backend, the suggested mechanism permit the OEM to still have indirect control over this virtual separated C-ITS data channel, by utilizing its default OEM <->CV data channel for commercial service operation and by providing the operator of the “C-ITS Data-Exchange” (or a given RO in a single country and single RO setup) with an OEM specific digital “C-ITS service certificate”.

The presence of such a valid OEM certificate can be cross-checked by a firewall function at the in-vehicle execution platform. In case of doubts the OEM can withdraw its certificate and utilize its default OEM <->CV channel to instruct the firewall at its CV to block all outgoing/incoming data to/from the C-ITS data channel.

In some embodiments, the proposed system includes full isolation of the in-vehicle software services and their execution, within a given CV. In some examples, this can be archived by deploying the “OEM in-vehicle client software services” and the “C-ITS in-vehicle client software services” at two physically separated processors within a given vehicle. These two physically separated processors can each be connected to a common cellular network 3GPP modem and further on to different virtual networks (network slices) at the connectivity providing mobile network (e.g. VPLMN).

In other examples, a CV can include high-performance in-vehicle processing circuitry (“HPC”) with hypervisor support and an embedded or an HPC-connected 3GPP modem. The full separation of the service execution in this kind of in-vehicle deployment structure would be achieved by the HPC hypervisor and by mapping the different service groups or virtual machines (and their data/configuration elements) to different memory partitions of the HPC.

In additional or alternative embodiments, the proposed system includes establishment of two (or more) independent wireless wide-range connections to/from a CV via a 3GPP cellular network that supports network slicing. In some examples, it is possible via the 3GPP Release 15, and subsequent Release specifications, starting with 4G Network vEPC (virtual Evolved Packet Core), via two separate vEPC instantiations. For the matter of separation of trust domains, an isolation of the corresponding radio resources (radio network partitioning) is not required, given that there is no direct access on application level to the radio network resources and to their utilization in a transportation channel setting.

In additional or alternative embodiments, the proposed system allows two (or more) network slices, sharing the same modem and SIM at a CV, to have two different termination points at two different trust domains, without sharing a common point of control outside of a given CV. In some examples, it may be required to route via a central OEM IT backend.

In some examples, builds of the concept that associates a 3GPP Network Slices with a virtually separated communication channel, established via a physical or virtual separated CSP network deployment structure. Every such Network Slice (or cellular network system deployment structure) is referenced via an S-NSSAI value. When the User Equipment (UE) appears, and during i.e. the 5G signaling, the UE requests to be connected to specific e2e network slice, identified by S-NSSAI. Then a GTP tunnel (which is UDP/IP-based) will be created. The GPRS Tunnelling Protocol (GTP) is a group of IP-based communications protocols used to carry general packet radio service (GPRS) within GSM, UMTS, LTE and 5G NR radio networks. A PDP Context (Packet Data Protocol) for an IP-based e2e connection from a UE (e.g. in-vehicle service) within a certain network slice, referenced by its S-NSSAI, can be established i.e. via an APN address that is mapped to the S-NSSAI of the cellular network that is providing the wireless connection to the UE (or CV in this case).

In a CV operation, one (reference) PDP context and communication channel is connecting all in-vehicle OEM services to the OEM IT backend (called “the first or default channel”, labeled channel (3) in FIG. 2 to FIG. 4). The communication connection is end-to-end encrypted. To maximize CV coverage and connectivity, most of all CVs are operated in permanent home-roaming. The VPLMN, that a CV in fact connects to, is determined via the roaming contract of the HPLMN. Every such OEM signs its corresponding global vehicle connectivity contracts with leading CSPs. Those leading CSPs utilized their roaming agreements to provide cross-country CV connectivity. The CV SIM profile is therefore determined by the OEM in conjunction with the connectivity contract with their lead-CSP (HPLMN). Such a (first) communication channel (from a given CV) terminates at the central OEM IT backend system. It constitutes the OEM trust domain (CV <->OEM Backend, called (B) in FIG. 2). Such a channel can be deployed with a (default) S-NSSAI MBB configuration, for example.

The C-ITS in-vehicle services can connect with another VPLMN network slice, identified via a different S-NSSAI (e.g., a “C-ITS S-NSSAI”) to constitute a dedicated “C-ITS Network Slice” at the CV-serving VPLMN. A communication channel for such in-vehicle C-ITS applications would utilize a different PDP context, established at the “C-ITS Network Slice”, with reference to the “C-ITS S-NSSAI”. This “C-ITS Network Slice” (called “second channel” here) can utilize a Local Breakout Gateway (LBO) to connect to the “national RO data endpoint” or a “C-ITS Data Exchange” system or network, under RO supervision, as illustrated at FIG. 3 and FIG. 4. That RO data endpoint constitutes the termination endpoint of the RO trust domain.

Thereby the two different in-vehicle client-service groups (OEM and C-ITS) would utilize two virtually separate communication networks, including their full separation of the corresponding network system function (vEPCs in 4G, or 5G SA or NSA core networks and AFs in 5G or similar structures in subsequent network generations), to connect a CV with two different termination points (OEM IT backend and National RO data endpoint) without sharing or passing a common user-plane Application Server (e.g. at the OEM IT systems). This implies that the C-ITS data channel is not routed via the OEM IT Backend and that both channels execute within two fully separated trust domains.

In additional or alternative embodiments, the proposed system allows the OEM in question to maintain control over the utilization of the second (C-ITS data) channel (into a second (RO) trust domain) that is not routed via the OEM IT backend. In some examples, the bidirectional C-ITS channel is treated as two unidirectional channels: A “To-CV-C-ITS-channel” that originates at the RO trust domain. And a “From-CV-C-ITS-channel” that originates at the CV in question. It can be assumed that at the CV platform both such C-ITS wireless communication channels (i.e. input channel and output channel) are firewalled towards the CV service execution platform. This is a state-of-the-art IT security recommendation.

Given that a global OEM has full control over its in-vehicle communication and service execution platform, the OEM can at all time monitor the data that shall be send from any C-ITS application at the “C-ITS in-vehicle application domain” to the outgoing “From-CV-C-ITS-channel”, via the CV firewall to the C-ITS network slice at the VPLMN; and finally arriving, via a LBO GW, at the RO trust domain (see channel (4) at FIG. 4).

In case the OEM discovers an indication of misconduct, regarding the sending of in-vehicle data via the C-ITS channel, the OEM can instruct the CV firewall of that vehicle to block all outgoing C-ITS data from this CV to the C-ITS data channel. This trigger could be set by an in-vehicle monitoring process (off-line mode) or after a corresponding CV-instruction has been received from the OEM backend, sent via the OEM data channel ((3) in FIG. 2 to FIG. 4) to the suspected vehicle (on-line mode).

The OEM control of the “To-CV-C-ITS-channel”, works as follows: A Global OEM generates an OEM corporate digital “C-ITS service/data certificate” with the purpose to have 3rd parties, for example to a RO C-ITS data exchange system operator, that is allowed to send data to the OEM's CVs, to sign all such data-payload with this OEM “C-ITS service certificate”. To enable this process the OEM shares the corresponding digital certificate with the (national) RO or with the entity that operates the backend termination point for the RO trust domain and thereby also the backend termination-point of the C-ITS LBO data channel. All data from the RO C-ITS trust domain that shall be received by the OEM's CV, driving in the geographic region of the RO in charge, shall be signed with this OEM certificate. This implies that all data towards a CV that travels via the “To-CV-C-ITS-channel” is signed with a valid OEM “C-ITS service certificate”.

Simultaneously the OEM utilizes its OEM default data channel (3) and provides the CV and its firewall process with the same digital certificate. This allows the CV firewall to have all data that is incoming via the “To-CV-C-ITS-channel”, with a valid OEM “C-ITS service” signature, forwarded to the CV C-ITS in-vehicle execution platform (ref. to Task 1).

In case the OEM suspects that a misconduct occurred at the RO (backend) trust domain, the OEM can mark its issued “C-ITS service certificate” as invalid and utilize its default OEM MBB channel (3) to alter the CV firewall setting to block further-on all incoming data from the “To-CV-C-ITS channel”. The OEM may notify the RO trust domain instance that the giving OEM “C-ITS service certificate” has been withdrawn.

This method allows a global OEM to maintain control over a wireless communication channel that is not passing via their OEM backend system.

In additional or alternative embodiments, the proposed system allows a 3rd party to audit, at any point in time, “its own (C-ITS) RO trust channel”, including the channel end points, to assure that no data from the OEM commercial trust domain got transported in or via the RO's C-ITS trust domain. In some examples, all deployment and operation cost coverage is linked to the provision and to the daily operation of such “C-ITS RO trust channel(s)” is to be carried by a (national) RO, e.g. on behalf of the state government, it is of utmost importance to ensure that no commercial minded consumer or OEM services execute via the RO C-ITS data channel. Meaning, that no commercial service operation gets subsidized by tax money which is meant to finance the operation of C-ITS road traffic safety and road traffic efficiency services, for the society's benefits. Such a verification task is subject to a 3rd party audit of deployed CVs driving at the geographic area of the responsible RO.

Subject to such an audit is the “(C-ITS) RO data channel”, implemented via a dedicated network slice, at a national CSP (VPLMN) and its two data endpoints. Namely the CV in question, with its group of C-ITS services on the one end (ref. to Task 1), and the RO (backend) trust domain on the other end.

In some examples, the embodiments described above, ensure a full separation of the C-ITS in-vehicle software services from any other in-vehicle service or service groups (such as in-vehicle consumer or OEM services). The separation can be ensured via dedicated in-vehicle execution platforms or via virtual machines and a process-and data space separation by a hypervisor function at a common HPC compute unit.

In both cases a hash value, over a trust-domain-specific in-vehicle memory partition, can be derived and stored at an independent 3rd party auditor reference database. Initially, this step can take place when the 3rd party auditor inspects and certifies that only C-ITS in-vehicle services are deployed to that physically or virtually separated C-ITS execution unit.

Later on, during an ad-hoc 3rd party inspection audit, a signature over the current in-vehicle C-ITS partition can be created and compared with the previously generated and filed signature for a comparative cross-check. With this mechanism, a 3rd party auditor can later on, at any point in time, discover if any of the in-vehicle C-ITS service components or their configuration data has been altered. This method allows to detect unauthorized modifications of the C-ITS in-vehicle execution environment.

There can be legitime reasons for differences between the signature value of the current in-vehicle C-ITS partition compared to the filed in-vehicle C-ITS partition at the initial step with the inspecting 3^{rd} party auditor. In some examples, a legitimate difference can occur if the deployed C-ITS services at the CV had experienced a software maintenance update or in case further C-ITS services had been deployed or withdrawn from the C-ITS service group at the inspected vehicle. All these changes in C-ITS configurations can occur under supervision and control of the CV OEM and can therefore be tracked back. Meaning, a chain of signature values can be generated, starting from the initial step with the signature from the initial 3^{rd} party certification, the signatures after any OEM controlled software or configuration updates to the deployed C-ITS service group at the CV, leading to the signature of the currently inspected CV in question. An intact signature update chain allows a 3^{rd} party auditor to backtrace and certify all rune-time modifications during the life-time of the vehicle.

The inspection of the “(C-ITS) RO data channel” implementation, at a given (national) CSP, is thanks to the utilization of the 3GPP network slicing concept a straight forward process. All (user plane) data that travels via the “(C-ITS) RO data channel”, at the CSP network, is passing network nodes (vEPC in 4G) and the 5G SA or NSA core networks and AFs (in 5G) that shall carry only C-ITS user plane data. The default CSP OSS monitoring functions and an on-site inspection process can re-assure a proper network system configuration at the national (VPLMN) CSP.

The inspection of the RO trust domain backend node (or RO C-ITS data exchange network) is also straight forward. None of the RO backend GWs or Application Servers (AS) shall provide internet access. And no consumer service shall have direct access to a RO AS or C-ITS Data-Exchange system or network which serves as a gateway function for the “(C-ITS) RO data channel”.

A Method to separate end-to-end Trust-Domains with cellular technology, suited for deployment and operation of global OEM CV services, with national RO services under global OEM control, with no C-ITS data leaving the national RO trust domain.

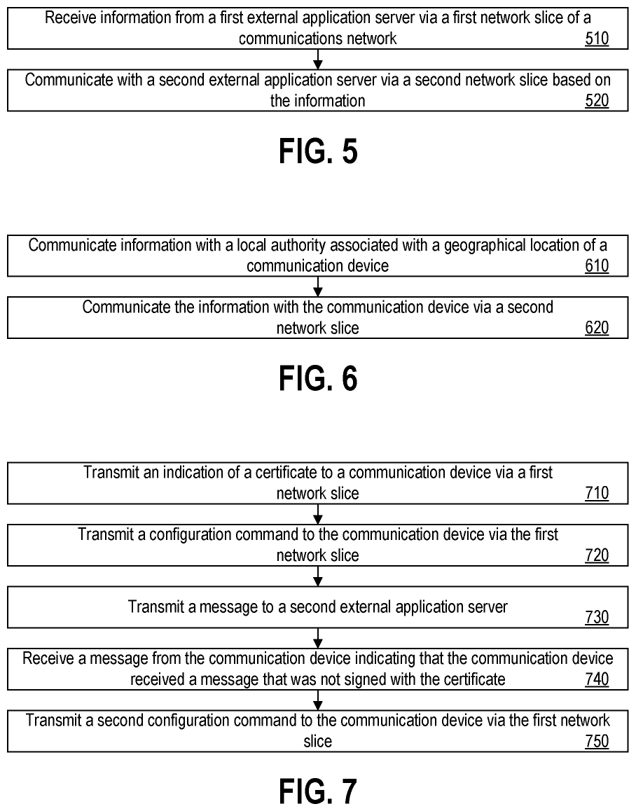

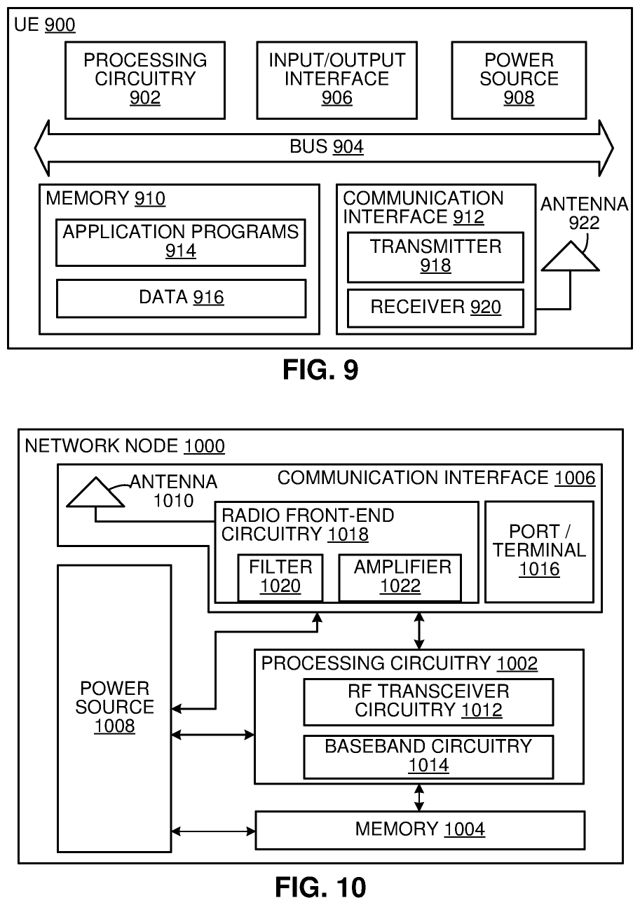

In the description that follows, while the communication device may be any of wireless device 812A, 812B, wired or wireless devices UE 812C, UE 812D, UE 900, virtualization hardware 1204, virtual machines 1208A, 1208B, or UE 1306, the UE 900 (also referred to herein as communication device 900) shall be used to describe the functionality of the operations of the communication device. Operations of the communication device 900 (implemented using the structure of the block diagram of FIG. 9) will now be discussed with reference to the flow chart of FIG. 5 according to some embodiments of inventive concepts. For example, modules may be stored in memory 910 of FIG. 9, and these modules may provide instructions so that when the instructions of a module are executed by respective communication device processing circuitry 902, processing circuitry 902 performs respective operations of the flow chart.

FIG. 5 illustrates examples of operations performed by a communication device. In some embodiments, the communication device includes at least one of: a manned vehicle; an unmanned vehicle; and a drone (e.g., a connected manned/unmanned flight or water transport object).

At block 510, processing circuitry 902 receives, via communication interface 912, information from a first external application server via a first network slice of a communications network. In some embodiments, the first external application server is provided by a first network node.

In additional or alternative embodiments, receiving the information from the first external application server via the first network slice includes receiving an indication of a configuration command and a certificate. The configuration command can indicate that the communication device is permitted to receive communications from the second external application server as long as the communications are signed by the certificate.

At block 520, processing circuitry 902 communicates, via communication interface 912, with a second external application server via a second network slice of the communications network based on the information. In some embodiments, the second external application server is provided by a second network node. In additional or alternative embodiments, the first network slice is associated with a first trust domain and the second network slice is associated with a second trust domain that is separate from the first trust domain. In some examples, the first trust domain includes a home public land mobile network, HPLMN, trust domain that connects the communicative device to a trust domain associated with the first external application server, and the second trust domain comprises a visited public land mobile network VPLMN, trust domain that connects the communication device to a trust domain associated with the second external application server that is different from the trust domain associated with the first external application server.

In additional or alternative examples, the first network slice and the first external application server are associated with an original equipment manufacturer, OEM, of the communication device. The second network slice and the second external application server are associated with a cooperative intelligent transportation system, C-ITS.

In additional or alternative embodiments, receiving the information from the first external server includes receiving, by a first processor of the communication device, the information from the first external server via the first network slice. Communicating with the second external application server includes communicating, by a second processor of the communication device, with the second external application server via the second network slice. In some examples, the first processor and the second processor are at least one of: physically separate processing circuits; and virtually separate processors provided by a common processing circuit.

In additional or alternative embodiments, communicating with the second external application server via the second network slice includes: receiving a message from the second external application server via the second network slice; determining that the message is signed with the certificate; and accessing information included in the message based on determining that the message is signed with the certificate.

In additional or alternative embodiments, communicating with the second external application server via the second network slice includes: receiving a message from the second external application server via the second network slice; determining that the message was not signed with the certificate; and responsive to determining that the message was not signed with the certificate, preventing a subsequent communication with the second external application server via the second network slice. In some examples, preventing the subsequent communication includes: transmitting an indication that the message was not signed with the certificate to the first external application server via the first network slice; and responsive to transmitting the indication, receiving a second configuration command indicating that the communication device is not permitted to communicate with the second external application server via the second network slice.

Various operations from the flow chart of FIG. 5 may be optional with respect to some embodiments of nodes and related methods.

In the description that follows, while the node may be any of the network node 810A, 810B, core network node 808, network node 1000, virtualization hardware 1204, virtual machines 1208A, 1208B, or network node 1304, the network node 1000 shall be used to describe the functionality of the operations of the network node. Operations of the network node 1000 (implemented using the structure of the block diagram of FIG. 10) will now be discussed with reference to the flow charts of FIGS. 6-7 according to some embodiments of inventive concepts. For example, modules may be stored in memory 1004 of FIG. 10, and these modules may provide instructions so that when the instructions of a module are executed by respective network node processing circuitry 1002, processing circuitry 1002 performs respective operations of the flow charts.

FIG. 6 illustrates an example of operations performed by a node. In some embodiments, the node includes a local breakout gateway, LBO, between a data exchange application server, associated with a local authority and a communication device. In additional or alternative embodiments, the node is configured to provide an external application server associated with the local authority.

At block 610, processing circuitry 1002 communicates, via communication interface 1006, information with a local authority associated with a geographical location of a communication device. In some embodiments, the communication device includes at least one of: a manned vehicle; an unmanned vehicle; and a drone (e.g., a connected manned/unmanned flight or water transport object).

At block 620, processing circuitry 1002 communicates, via communication interface 1006, the information with the communication device via a second network slice. The second network slice is separate from a first network slice that is associated with a remote entity associated with the communication device. In some embodiments, the remote entity is associated with an original equipment manufacturer, OEM, of the communication device, and the local authority is associated with a cooperative intelligent transportation system, C-ITS.

In some embodiments, the information includes an indication of a certificate provided by the remote entity.

In additional or alternative embodiments, the first network slice is associated with a first trust domain and the second network slice is associated with a second trust domain that is separate from the first trust domain. In some examples, the first trust domain is a first end-to-end trust domain that includes a combined first home public land mobile network, HPLMN, trust domain associated with a first external application server and a visited public land mobile network, VPLMN, trust domain associated with the communication device. The second trust domain is a second end-to-end trust domain that includes a second external application server and a local breakout gateway of the VPLMN trust domain.

FIG. 7 illustrates an example of operations performed by a node configured to provide a first external application server. In some embodiments, the node (remote entity) is associated with an original equipment manufacturer, OEM, of the communication device, and the local authority is associated with a cooperative intelligent transportation system, C-ITS.

At block 710, processing circuitry 1002 transmits, via communication interface 1006, an indication of a certificate to a communication device via a first network slice. In some embodiments, the communication device includes at least one of: a manned vehicle; an unmanned vehicle; and a drone (e.g., a connected manned/unmanned flight or water transport object).

At block 720, processing circuitry 1002 transmits, via communication interface 1006, a configuration command to the communication device via the first network slice. The configuration command can indicate that the communication device is permitted to receive communications from the second external application server as long as the communications are signed by the certificate.

In some embodiments, the first network slice is associated with a first trust domain and the second network slice is associated with a second trust domain that is separate from the first trust domain. In some examples, the first trust domain is a first end-to-end trust domain that includes a combined first home public land mobile network, HPLMN, trust domain associated with a first external application server and a visited public land mobile network, VPLMN, trust domain associated with the communication device. The second trust domain is a second end-to-end trust domain that includes a second external application server and a local breakout gateway of the VPLMN trust domain.

At block 730, processing circuitry 1002 transmits, via communication interface 1006, a first message to a second external application server. The first message requests that the certificate be added to messages transmitted by the second external application server to the communication device via a second network slice that is separate from the first network slice.

At block 740, processing circuitry 1002 receives, via communication interface 1006, a second message from the communication device via the second network slice indicating that the communication device received a third message from the second external application server and that the third message was not signed with the certificate.

At block 750, processing circuitry 1002 transmits, via communication interface 1006, a second configuration command to the communication device via the first network slice. The second configuration command indicates that the communication device is not permitted to communicate with the second external application server.

Various operations from the flow charts of FIGS. 6-7 may be optional with respect to some embodiments of nodes and related methods.

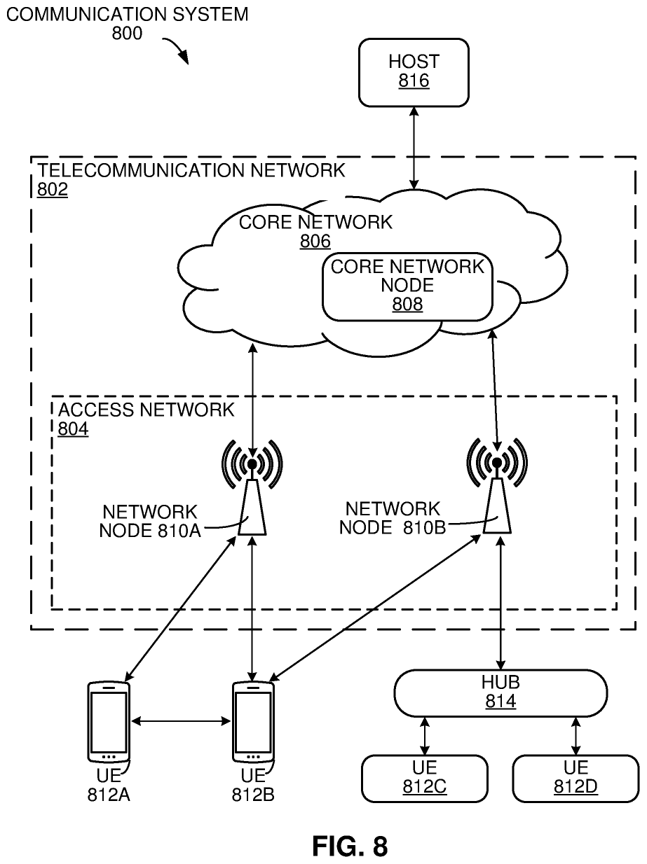

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access node or non-3GPP access point. Moreover, as will be appreciated by those of skill in the art, the network nodes 810 are not necessarily limited to an implementation in which a radio portion and a baseband portion are supplied and integrated by a single vendor. Thus, it will be understood that the network nodes 810 may include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 810 facilitate direct or indirect connection of user equipment (UE), such as by connecting wireless devices 812a, 812b, 812c, and 812d (one or more of which may be generally referred to as UEs 812) to the core network 806 over one or more wireless connections. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device (e.g., a vehicle onboard unit or vehicle electronic control unit), etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010.

Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment.

Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

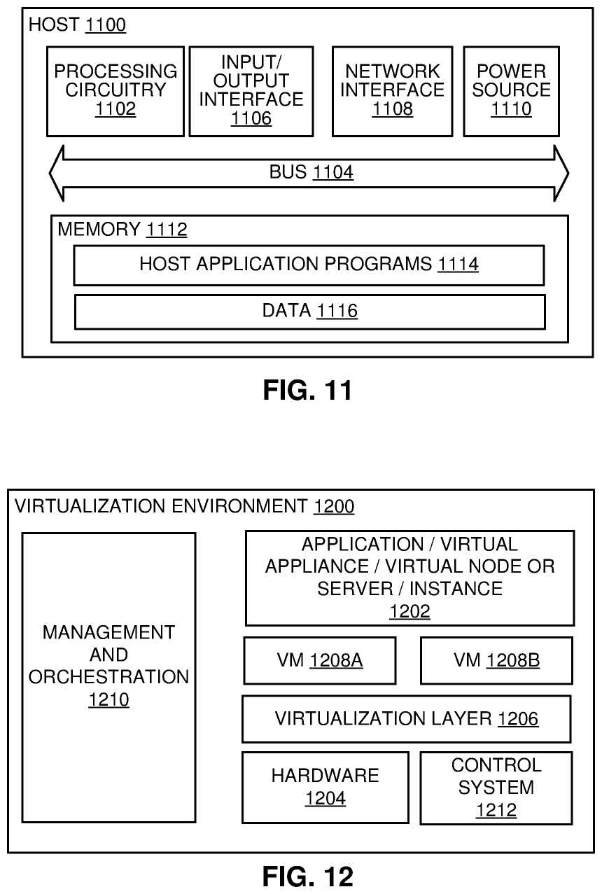

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

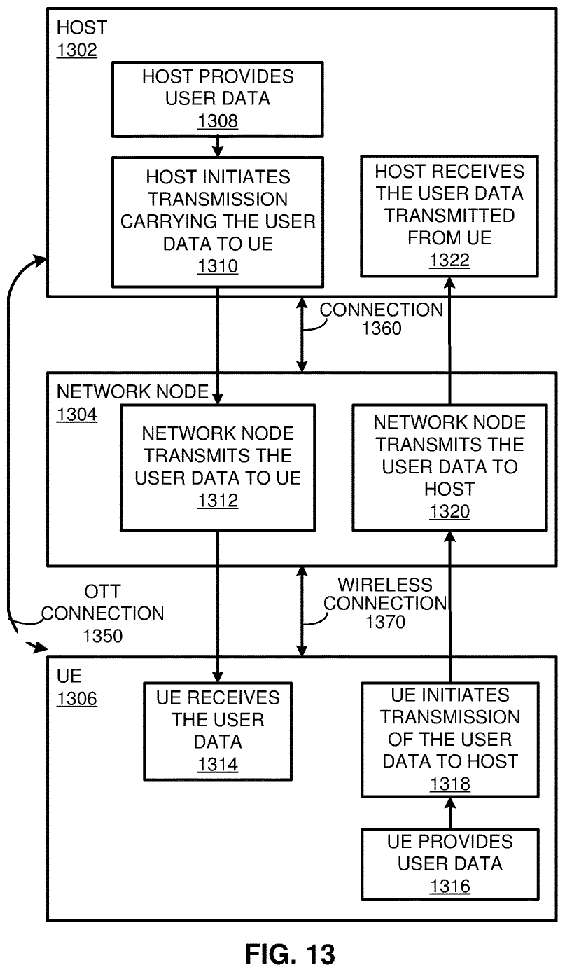

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may enable local authorities (e.g., ROs) to communicate or receive important information with a communication device via an end-to-end trust domain using cellular technology separately to/from another end-to-end trust domain associated with a remote entity.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc. ; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
communicating (610) information with a local authority associated with a geographical location of a communication device; and
communicating (620) the information with the communication device via a second network slice, the second network slice being separate from a first network slice that is associated with a remote entity associated with the communication device.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
communicating (610) information with a local authority associated with a geographical location of a communication device; and
communicating (620) the information with the communication device via a second network slice, the second network slice being separate from a first network slice that is associated with a remote entity associated with the communication device.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   communicating (610) information with a local authority associated with a geographical location of a communication device; and
   communicating (620) the information with the communication device via a second network slice, the second network slice being separate from a first network slice that is associated with a remote entity associated with the communication device.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
communicating (610) information with a local authority associated with a geographical location of a communication device; and
communicating (620) the information with the communication device via a second network slice, the second network slice being separate from a first network slice that is associated with a remote entity associated with the communication device.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of the any of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   communicating (610) information with a local authority associated with a geographical location of a communication device; and
   communicating (620) the information with the communication device via a second network slice, the second network slice being separate from a first network slice that is associated with a remote entity associated with the communication device.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   receiving (510) information from a first external application server via a first network slice of a communications network; and
   communicating (520) with a second external application server via a second network slice based on the information.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
receiving (510) information from a first external application server via a first network slice of a communications network; and
communicating (520) with a second external application server via a second network slice based on the information.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
   receiving (510) information from a first external application server via a first network slice of a communications network; and
   communicating (520) with a second external application server via a second network slice based on the information.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
receiving (510) information from a first external application server via a first network slice of a communications network; and
communicating (520) with a second external application server via a second network slice based on the information.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

1. A method of operating a communication device, the method comprising:
receiving information from a first external application server via a first network slice of a communications network; and
communicating with a second external application server via a second network slice of the communications network based on the information.

2. The method of claim 1, wherein the first external application server is provided by a first network node, and
wherein the second external application server is provided by a second network node.

3. The method of claim 1, wherein receiving the information from the first external server comprises receiving, by a first processor of the communication device, the information from the first external server via the first network slice, and
wherein communicating with the second external application server comprises communicating, by a second processor of the communication device, with the second external application server via the second network slice,
wherein the first processor and the second processor are at least one of:
physically separate processing circuits; and
virtually separate processors provided by a common processing circuit.

4. The method of claim 1, wherein receiving the information from the first external application server via the first network slice comprises receiving an indication of a configuration command and a certificate, the configuration command indicating that the communication device is permitted to receive communications from the second external application server as long as the communications are signed by the certificate.

5. The method of claim 4, wherein communicating with the second external application server via the second network slice comprises:
receiving a message from the second external application server via the second network slice;
determining that the message is signed with the certificate; and
accessing information included in the message based on determining that the message is signed with the certificate.

6. The method of claim 4, wherein communicating with the second external application server via the second network slice comprises:
receiving a message from the second external application server via the second network slice;
determining that the message was not signed with the certificate; and
responsive to determining that the message was not signed with the certificate, preventing a subsequent communication with the second external application server via the second network slice.

7. The method of claim 6, wherein the configuration command is a first configuration command, and
wherein preventing the subsequent communication comprises:
transmitting an indication that the message was not signed with the certificate to the first external application server via the first network slice; and
responsive to transmitting the indication, receiving a second configuration command indicating that the communication device is not permitted to communicate with the second external application server via the second network slice.

8. The method of claim 4, wherein communicating with the second external application server via the second network slice comprises:
receiving a message from the second external application server via the second network slice;
determining that the message is suspicious; and
responsive to determining that the message is suspicious, preventing a subsequent communication with the second external application server via the second network slice.

9. The method of claim 8, wherein the configuration command is a first configuration command, and
wherein preventing the subsequent communication comprises:
transmitting an indication that the message is suspicious to the first external application server via the first network slice; and
responsive to transmitting the indication, receiving a second configuration command indicating that the communication device is not permitted to communicate with the second external application server via the second network slice.

10. The method of claim 4, wherein communicating with the second external application server via the second network slice comprises:
receiving a message from the first external application server via the first network slice indicating that the communication device is not permitted to communicate with the second external application server via the second network slice.

11. The method of claim 1, wherein the communication device comprises at least one of:
a manned vehicle;
an unmanned vehicle; and
a drone.

12. The method of any claim 1, wherein the first network slice is associated with a first trust domain and the second network slice is associated with a second trust domain that is separate from the first trust domain.

13. The method of claim 12, wherein the first trust domain comprises a home public land mobile network, HPLMN, trust domain that connects the communicative device to a trust domain associated with the first external application server, and
wherein the second trust domain comprises a visited public land mobile network VPLMN, trust domain that connects the communication device to a trust domain associated with the second external application server that is different from the trust domain associated with the first external application server.

14. The method of claim 1, wherein the first network slice and the first external application server are associated with an original equipment manufacturer, OEM, of the communication device, and
wherein the second network slice and the second external application server are associated with a cooperative intelligent transportation system, C-ITS.

15. A method of operating a node, the method comprising:
communicating information with a local authority associated with a geographical location of a communication device; and
communicating the information with the communication device via a second network slice, the second network slice being separate from a first network slice that is associated with a remote entity associated with the communication device.

16. The method of claim 15, wherein the information includes an indication of a certificate provided by the remote entity.

17. The method of claim 15, wherein the communication device comprises at least one of:
a manned vehicle;
an unmanned vehicle; and
a drone.

18. The method of claim 15, wherein the first network slice is associated with a first trust domain and the second network slice is associated with a second trust domain that is separate from the first trust domain.

19. The method of claim 18, wherein the first trust domain is a first end-to-end trust domain that comprises a combined first home public land mobile network, HPLMN, trust domain associated with a first external application server and a visited public land mobile network, VPLMN, trust domain associated with the communication device, and
wherein the second trust domain is a second end-to-end trust domain that comprises a second external application server and a local breakout gateway of the VPLMN trust domain.

20. The method of claim 15, wherein the remote entity is associated with an original equipment manufacturer, OEM, of the communication device, and
wherein the local authority is associated with a cooperative intelligent transportation system, C-ITS.

21-41. (canceled)
